(19) United States
(12) Patent Application Publication
(10) Pub. No.: US 2001/0044028 A1
(43) Pub. Date: Nov. 22, 2001

(54) Diamond-like carbon coated pet film and pet film glass laminate glazing structures for added hardness and abrasion resistance

(76) Inventors: Jerrel Charles Anderson, Vienna, WV (US); Don M. Coates, Sante Fe, NM (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/747,674

(22) Filed: Dec. 22, 2000

Related U.S. Application Data
(60) Provisional application No. 60/174,051, filed on Dec. 30, 1999.

(51) Int. Cl. B32B 9/00

(52) U.S. Cl. 428/408; 428/336

(57) ABSTRACT

The present invention is a non-metallic article that has been coated with a diamond-like carbon (DLC) coating. A DLC coated article of the present invention has increased hardness and increased abrasion resistance when compared with these same properties of the article prior to the article being coated. DLC coatings of the present invention are applied in a chamber filled with hydrocarbon plasma and with application of electrical pulses.

### BACKGROUND OF THE INVENTION

1. Field of the Invention

This invention relates to plastic articles having increased hardness and abrasion resistance. This invention particularly relates to soft plastic articles coated to increase hardness and abrasion resistance.

2. Description of the Prior Art

Protective coatings on surfaces that come in contact with other objects can be desirable in applications where the surface can be scratched or abraded by such contact, and where such wear on the surface is undesirable. In addition, protective coatings that are also hard coatings can be desirable in applications where a low coefficient of friction is necessary or desirable. Applying DLC coatings to hard metallic surfaces has been carried out using the plasma source ion implantation (PSII) technique, wherein a potential is applied to an article that is to be coated in order to attract the plasma ions to the surface of the article. U.S. Pat. No. 4,764,394 describes the PSII technique, and how it can be useful for implanting ions beneath the surface of various materials. The PSII method utilizes high voltage of typically greater than 20 kilovolts to drive plasma ions beneath the surface of a target material.

It can be desirable to apply a hard coating onto the surface of an article having an initially soft surface to increase surface hardness and increase abrasion resistance.

### SUMMARY OF THE INVENTION

In one aspect, the present invention is a coated plastic article having a surface comprising a layer of a diamond-like carbon (DLC) coating on the surface of a soft plastic.

In one aspect, the present invention is a coated plastic article having a surface comprising a layer of a diamond-like carbon (DLC) coating on the surface of a soft plastic, wherein the plastic is a PET film.

In another aspect, the present invention is an article comprising a layer of a DLC coating on a soft plastic surface, wherein the plastic surface is coated in a process comprising the step of applying a high-voltage electrical pulse to the surface while the surface is immersed in a hydrocarbon plasma.

### DETAILED DESCRIPTION

In one embodiment, the present invention is a coated plastic article having an initially soft surface prior to application of a hard coating. The soft plastic can be a plastic material such as polyethylene terephthalate (PET), polymethylmethacrylate (PMMA), polycarbonate (PC), or like materials. Plastics suitable for use in the present invention can have a hardness as measured by a Berkowich Indenter and expressed in GPa, of less than about 0.3 to about 0.5.

A DLC coated article of the present invention can be obtained by applying a high-voltage potential to a suitable plastic article while the article is immersed in plasma. The plasma can consist of any hydrocarbon gas or mixture of gasses, such as, for example, methane, ethane, any or all isomers of propane, any or all isomers of butane, ethene, any or all isomers of propene, acetylene, propyne, 1-butyne, 2-butyne, similar compounds, and mixtures of any of these. Preferably the plasma includes acetylene.

In the practice of the present invention, a high-voltage potential can be applied to an article immersed in plasma for periods of shorter or longer duration, depending on the thickness of the DLC coating desired. Thicker DLC coatings require longer periods of exposure to plasma, while thinner DLC coatings do not require as long a period of exposure as a potential is applied. Coatings of from about 0.01 to about 5 microns are obtained in the practice of the present invention. Preferably coatings of from about 0.05 to about 4.5 microns are obtained. More preferably coatings of from about 0.1 to about 4.0 microns, and most preferably coatings of from about 0.5 to about 3.5 microns are obtained.

High voltage, as used herein, means a potential of at least about 0.5 kilovolt (kV), preferably at least about 1.0 kV, more preferably at least about 1.5 kV, and most preferably at least about 2 kV. In the practice of the present invention, a high voltage potential can be applied to a second article that is in contact with the article to be coated. Preferably, the second article is conductive and is in contact with at least about 30% of the surface area of the article. Preferably, 100% of the surface to be coated is exposed to the plasma.

A DLC coated article of the present invention can be obtained by a process comprising the steps: cleaning the surface of the article to be coated; placing the article in contact with a conductive material; placing the article in a PSII (plasma source ion implantation) chamber; removing air and moisture from the samples by evacuating the chamber; further cleaning the surfaces by blowing an inert gas over the surfaces; introducing a hydrocarbon vapor to the chamber; and applying an electrical pulse of voltage in the range of less than about 10 kV, preferably less than about 5 kV, more preferably less than about 4 kV, and most preferably less than about 3 kV to the chamber and its contents, to obtain a DLC coated article.

An electrical pulse can be applied to the target object to be coated for a sufficient time to obtain coatings of various thicknesses. The pulse can be be applied multiple times in order to obtain the desired coating. For example, coating thicknesses in the range of from about 0.01 to about 5 microns can be obtained by subjecting the article the plasma for up to about 24 hours.

The hardness of an article coated with a DLC coating is increased compared to the hardness of the non-coated article. The penetration depth of an impinging load is decreased for a coated article compared to that of a non-coated article. The coefficient of friction of a DLC coated article of the present invention is decreased compared to that of the non-coated article.

DLC coated articles of the present invention can be useful as, for example, sidelights on automobiles, automobile rock shields, etc.

### EXAMPLES

The following Examples are presented to illustrate the invention described herein, but in no way are meant to limit the scope of the present invention.

### Example 1

Polyethyleneterephthalate (PET) clear films, 0.007 inches thick, were flame-treated prior to being coated. The PET films were laid onto a conductive metal plate, located inside of the PSII chamber, the plate being connected to the pulse generator which was used to create the pulsed potential required to attract acetylene plasma moieties onto the exposed PET surfaces. The films were held down at the edges by thin aluminum strips. The metal plate was cooled to —° C. The PET films were treated in three separate runs of varying lengths.

Sample A was treated for 1 hour and a DLC coating of about 0.2 microns was obtained. This coating was very glossy and uniform in appearance with an amber color and low haze, good transparency and excellent see-through clarity.

Samples B and C were coated together for 8 hours in a second run to give approximately a 1.0 micron thick DLC coating that was darker in color but with good see-through clarity and low haze.

Sample C was exposed to about 9 hours additional treatment in order to apply more DLC onto the already present 1.0 micron DLC coating to give a final coating thickness of about 2.0 microns. This thick DLC coating was very dark and glossy with good uniformity of appearance. This sample was opaque.

These samples were measured for coating thickness using a Perthometer profilometer and they were also measured for surface hardness and surface young's modulus using a Berkovich Indenter calibrated with fused silica. Coefficient of friction was measured using a NANO Indenter XP instrument. An uncoated PET film was used as a control and a polysiloxane Abrasion Resistant Coated (PARC) PET film was tested as well for comparison purposes. The PARC coated sample was a standard commercial grade of abrasion resistant film commonly used in glazing applications. It has excellent scratch and abrasion resistance. Results are given in Table 1 below.

TABLE 1

| | | | | | | Coeff. |
|---|---|---|---|---|---|---|
| | DLC | | Young's | | | of |
| Sample | Thickness | Hardness | Modulus | Haze | Clarity | Friction |
| PET Film | No DLC | 0.5 | 4.45 | 0.6 | 99.9 | 0.9 |
| A | 0.2 | 5.4 | 35 | 0.8 | 99.7 | 0.2 |
| B | 1.0 | 10 | 75 | 3.5 | 98.9 | 0.2 |
| C | 2.0 | 20 | 115 | | | 0.2 |
| PARC on | No DLC | 3 | 14 | 0.4 | 100 | 0.1 |
| PET | | | | | | |

The DLC coating has a much lower coefficient of friction and is much harder than the PET film. The DLC also has a much higher stiffness as reflected in the Young's modulus figures. The combination of properties offered by coating with DLC gives a surface that is much more resistant to abrasion and scratching. The PARC falls intermediate in properties between uncoated PET film and the DLC coated films.

The DLC coatings covered the PET film samples very uniformly and this was a surprise in that a non-conductive substrate film could be coated so well by the PSII method.

The DLC coatings are very low in haze and do not affect clarity significantly. DLC coatings can be used in glazing applications based on these optical properties.

### Example 2

The coated films from Example 1 were laminated to glass using standard autoclaving conditions of 30 minutes under pressure at 125-150° C. The coated PET films were bonded to glass using BUTACITE® polyvinyl butyral (PVB) sheeting with the coated sides of the PET films facing away from the PVB sheeting. A sacrificial glass coverplate was used on the coated PET films to give the sandwich an optically flat surface necessary for glazing applications. After autoclaving, the glass cover plate was removed and discarded. The resultant DLC/PET/PVB/GLASS laminate was clear and the DLC coated plastic side was optically flat and suitable for glazing applications. These laminates were tested for abrasion resistance using the Taber Abrader test (ANSI Z-26.1 Standard, Test Number 34) and the degree of abrasion was compared from photomicrographs of the surfaces. They were also tested for coating adhesion before and after immersion in boiling water for 2 hours. The coating adhesion was tested using the standard tape peel adhesion approach (ASTM D 3359-87) utilizing “PERMACEL” tape having a peel strength against steel of 40 ounces/inch. Results are given in Table 2 below.

TABLE 2

| | DLC Thickness | |
|---|---|---|
| Sample | Microns | Taber Abraded Surface Scratching |
| PET Film | No DLC | Extremely heavy scratching |
| | | over 98% of surface |
| A | 0.2 | Extremely heavy scratching over |
| | | 95% of surface |
| B | 1.0 | Very light scratches over 1-2% |
| | | of surface |
| C | 2.0 | Occasional very light scratch |
| PARC on PET | No DLC | Moderate scratching with occasional |
| | | tearing of PARC |

The DLC coatings exhibit excellent adhesion to the PET film both before and after immersion in boiling water for 2 hours. No blisters formed with any of the coatings with immersion in boiling water.

### Example 3

Three different plastic substrates were coated together using the PSII apparatus and technique already described with a coating time of 1 hour to give a coating of about 0.17 microns. The plastics treated were PET film (the sample “A” in preceding examples), LUCITE® (registered trademark of ICI) polymethylmethacrylate sheeting, and LEXAN® (registered trademark of General Electric) polycarbonate sheeting. All three samples coated uniformly with an amber colored DLC coating that was clear and without haze. The samples were measured for hardness and Young's modulus to determine the affect of the DLC coating on scratch and abrasion resistance. Results are shown in Table 3

TABLE 3

| | | Hardness | Young's Modulus |
|---|---|---|---|
| Sample | Coating | GPa | GPa |
| PET Film | None | 0.5 | 4.5 |
| A | DLC | 5.4 | 35 |
| Lucite | None | 0.35 | 3.5 |
| Lucite | DLC | 3.75 | 32 |
| Lexan | None | 0.3 | 3.5 |
| Lexan | DLC | 4.0 | 25 |

The 0.2 micron DLC coating on all three plastics significantly increases the hardness and the stiffness of the surfaces.

1. A coated plastic article having a surface comprising a layer of a diamond-like carbon (DLC) coating on the surface of a soft plastic material.

2. The article of claim 1, wherein the plastic surface is coated in a process comprising the step of applying an electrical pulse of from about 0.05 to about 10 kilovolts to the article while the article is immersed in a chamber filled with a hydrocarbon plasma.

3. The article of claim 2, wherein the plastic is a PET film.

4. The article of claim 3, wherein the coating is from about 0.01 to about 5 microns thick.

5. The article of claim 4, wherein the coating is from about 0.05 to about 4.5 microns thick.

6. The article of claim 5, wherein the coating is from about 0.1 to about 4.0 microns thick.

7. The article of claim 6 wherein the voltage of the electrical pulse is from about 1.0 to about 10 kV.

8. The article of claim 7 wherein the voltage of the electrical pulse is from about 1.0 to about 5 kV.

9. The article of claim 8 wherein the voltage of the electrical pulse is from about 1.5 to about 4 kV.

10. The article of claim 9 wherein the voltage of the electrical pulse is from about 2 to about 3 kV.
